(19) United States
(12) Patent Application Publication
(10) Pub. No.: US 2019/0036250 A1
(43) Pub. Date: Jan. 31, 2019

(54) ELECTROMAGNETIC RELAY UNIT

(71) Applicant: FUJITSU COMPONENT LIMITED, Tokyo (JP)

(72) Inventors: Kohei Takahashi, Tokyo (JP); Masahiro Kaneko, Tokyo (JP); Miki Kitahara, Tokyo (JP); Nobuo Yatsu, Tokyo (JP); Ying Li, Tokyo (JP); Katsuaki Koshimura, Tokyo (JP)

(21) Appl. No.: 16/040,983

(22) Filed: Jul. 20, 2018

(30) Foreign Application Priority Data
Jul. 28, 2017 (JP) 2017-146211

(51) Int. Cl. H01R 12/71; H01H 50/04; H01H 50/14; H01R 13/22; H01R 12/70

(52) U.S. Cl. CPC H01R 12/716; H01H 50/048; H01R 12/7023; H01R 13/22; H01H 50/14

(57) ABSTRACT

An electromagnetic relay unit includes an electromagnetic relay; a socket that connects the electromagnetic relay to a mount board; a first terminal provided at the electromagnetic relay and including a first plate portion; and a second terminal provided at the socket to be connectable with the first terminal, and including a second plate portion, the first plate portion and the second plate portion being provided to face with each other when the electromagnetic relay and the socket are connected with each other, at least one of the first plate portion and the second plate portion including a projection that contacts the other of the first plate portion and the second plate portion.

### CROSS-REFERENCE TO RELATED APPLICATION

The present application is based on and claims the benefit of priority of Japanese Priority Application No. 2017-146211 filed on Jul. 28, 2017, the entire contents of which are hereby incorporated by reference.

### BACKGROUND

### 1. Field of the Invention

The present invention relates to an electromagnetic relay unit.

### 2. Description of the Related Art

When an electromagnetic relay is mounted on a mount board, terminals of the electromagnetic relay are bonded to the mount board by solder. Meanwhile, when the electromagnetic relay is operated, vibration occurs. Then, when the vibration transmits to the mount board via components of the electromagnetic relay and the solder, the mount board may be vibrated and sound noise may be generated.

Patent Document 1, for example, discloses a method of suppressing transmission of vibration generated by operation of an electromagnetic relay to a mount board, by bonding relay terminals of the electromagnetic relay to U-shaped springs provided at an external board.

However, by the method disclosed in Patent Document 1, as components of the electromagnetic relay are physically connected to the mount board, even when the springs are provided on a transmission path of the vibration, the vibration generated by the operation of the electromagnetic relay is not sufficiently suppressed and sound noise is generated by the vibration of the mount board.

### PATENT DOCUMENT

[Patent Document 1] Japanese Laid-open Patent Publication No. H10-125197

### SUMMARY OF THE INVENTION

According to an embodiment, there is provided an electromagnetic relay unit including an electromagnetic relay; a socket that connects the electromagnetic relay to a mount board; a first terminal provided at the electromagnetic relay and including a first plate portion; and a second terminal provided at the socket to be connectable with the first terminal, and including a second plate portion, the first plate portion and the second plate portion being provided to face with each other when the electromagnetic relay and the socket are connected with each other, at least one of the first plate portion and the second plate portion including a projection that contacts the other of the first plate portion and the second plate portion.

### BRIEF DESCRIPTION OF THE DRAWINGS

Other objects, features and advantages of the present invention will become more apparent from the following detailed description when read in conjunction with the accompanying drawings.

FIG. 1 is a perspective view of a first embodiment illustrating a state in which an electromagnetic relay and a socket are separated;

FIG. 2 is a perspective view illustrating the state of FIG. 1 where a main body of the socket is not illustrated;

FIG. 3 is a perspective view of the first embodiment illustrating a state in which the electromagnetic relay and the socket are fitted with each other;

FIG. 4 is a perspective view illustrating the state of FIG. 3 where the main body of the socket is not illustrated;

FIG. 5 is a perspective view illustrating the electromagnetic relay seen from a lower side;

FIG. 6 is a perspective view illustrating a terminal of the electromagnetic relay;

FIG. 7 is a perspective view illustrating an example of a structure in which a plurality of projections are provided at the terminal;

FIG. 8 is a perspective view of a second embodiment illustrating a state in which an electromagnetic relay and a socket are separated;

FIG. 9 is a perspective view illustrating the state of FIG. 8 where a main body of the socket is not illustrated;

FIG. 10 is an elevation view of the second embodiment illustrating a state in which the electromagnetic relay and the socket are fitted with each other;

FIG. 11 is an elevation view illustrating the state of FIG. 10 where the main body of the socket is not illustrated;

FIG. 12 is a perspective view of a third embodiment illustrating a state in which an electromagnetic relay and a socket are separated;

FIG. 13 is a perspective view illustrating the state of FIG. 12 where a main body of the socket is not illustrated;

FIG. 14 is a perspective view of the third embodiment illustrating a state in which the electromagnetic relay and the socket are fitted with each other;

FIG. 15 is a perspective view illustrating the state of FIG. 14 where the main body of the socket is not illustrated;

FIG. 16 is a partially cross-sectioned perspective view of the socket of the third embodiment;

FIG. 17 is a perspective view of a fourth embodiment illustrating a state in which an electromagnetic relay and a socket are separated;

FIG. 18 is a perspective view illustrating the state of FIG. 17 where a main body of the socket is not illustrated;

FIG. 19 is a perspective view of the fourth embodiment illustrating a state in which the electromagnetic relay and the socket are fitted with each other;

FIG. 20 is a perspective view illustrating the state of FIG. 19 where the main body of the socket is not illustrated;

FIG. 21 is an enlarged partially cross-sectioned perspective view illustrating the vicinity of a terminal of the socket of the fourth embodiment;

FIG. 22 is an enlarged partially cross-sectioned perspective view illustrating the vicinity of terminals at a state in which the electromagnetic relay and the socket are fitted with each other;

FIG. 23 is a perspective view of a modified example of the fourth embodiment illustrating a state in which an electromagnetic relay and a socket are separated;

FIG. 24 is a perspective view of the modified example of the fourth embodiment illustrating a state in which the electromagnetic relay is inserted in the socket;

FIG. 25 is a perspective view of a fifth embodiment illustrating a state in which an electromagnetic relay and a socket are separated;

FIG. 26 is a perspective view illustrating the state of FIG. 25 where a main body of the socket is not illustrated;

FIG. 27 is a perspective view of the fifth embodiment illustrating a state in which the electromagnetic relay and the socket are fitted with each other;

FIG. 28 is a perspective view illustrating the state of FIG. 27 where the main body of the socket is not illustrated;

FIG. 29 is a side view illustrating an example of a structure in which projections are provided at both surfaces of a terminal of the fifth embodiment;

FIG. 30 is a perspective view of a sixth embodiment illustrating an electromagnetic relay;

FIG. 31 is a side view illustrating a terminal of the electromagnetic relay of the sixth embodiment;

FIG. 32 is a partially cross-sectioned perspective view illustrating the socket of the sixth embodiment;

FIG. 33 is a side view illustrating a terminal of the socket of the sixth embodiment;

FIG. 34 is a view of a seventh embodiment schematically illustrating an example of a relationship between an arrangement of plate portions of terminals of a socket and an arrangement of plate portions of terminals of an electromagnetic relay; and

FIG. 35 is a view of the seventh embodiment schematically illustrating another example of a relationship between an arrangement of the plate portions of the terminals of the socket and an arrangement of the plate portions of the terminals of the electromagnetic relay.

### DESCRIPTION OF THE EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

In the drawings, the same components are given the same reference numerals, and explanations are not repeated.

### First Embodiment

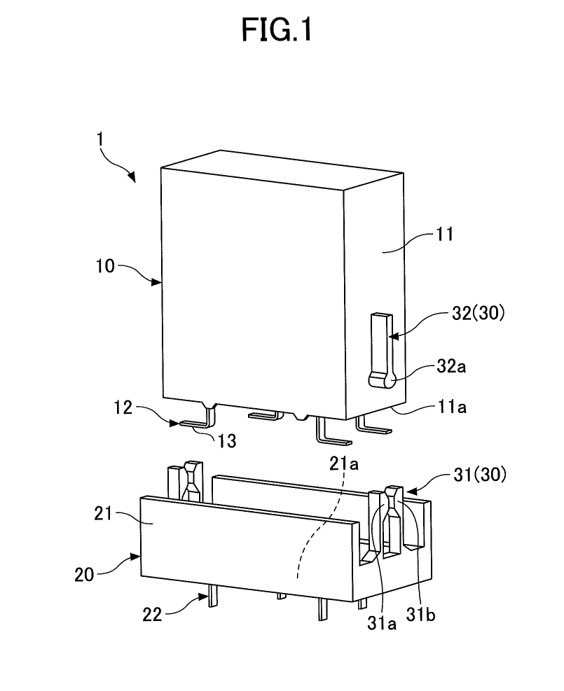

With reference to FIG. 1 to FIG. 6, an electromagnetic relay unit 1 of a first embodiment is described. In the following, an upper-lower direction of FIG. 1 is referred to as an “upper-lower direction”. This direction is a facing direction of a lower surface 11a of an electromagnetic relay 10 and a bottom surface 21a of a socket 20. However, the upper-lower direction is not necessary a vertical direction. A direction that is perpendicular to the upper-lower direction is referred to as a “horizontal direction”.

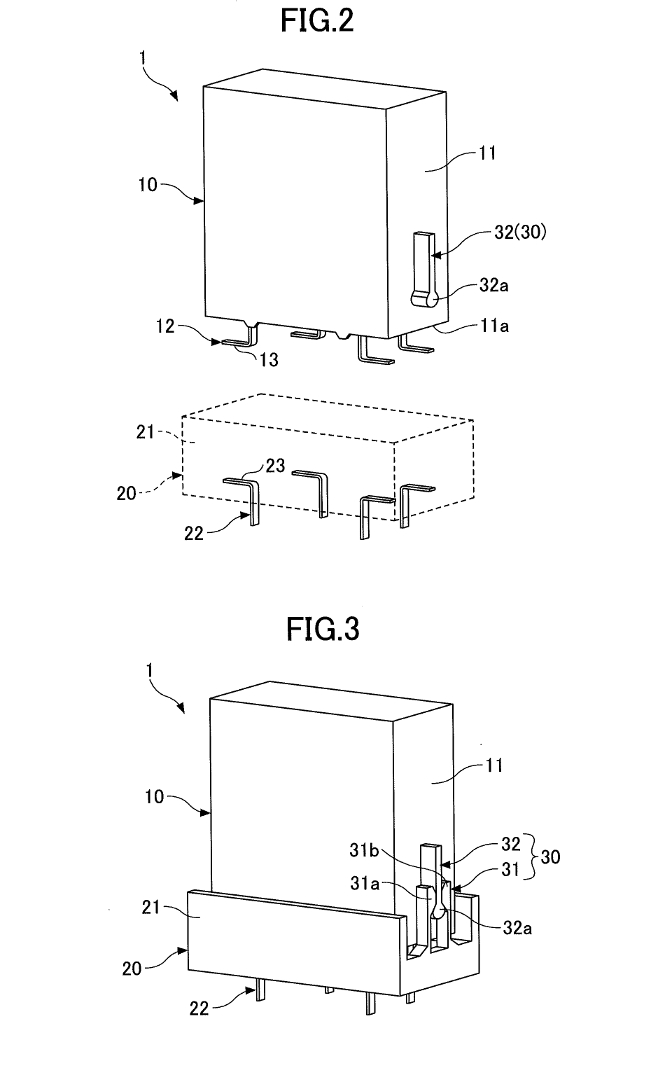

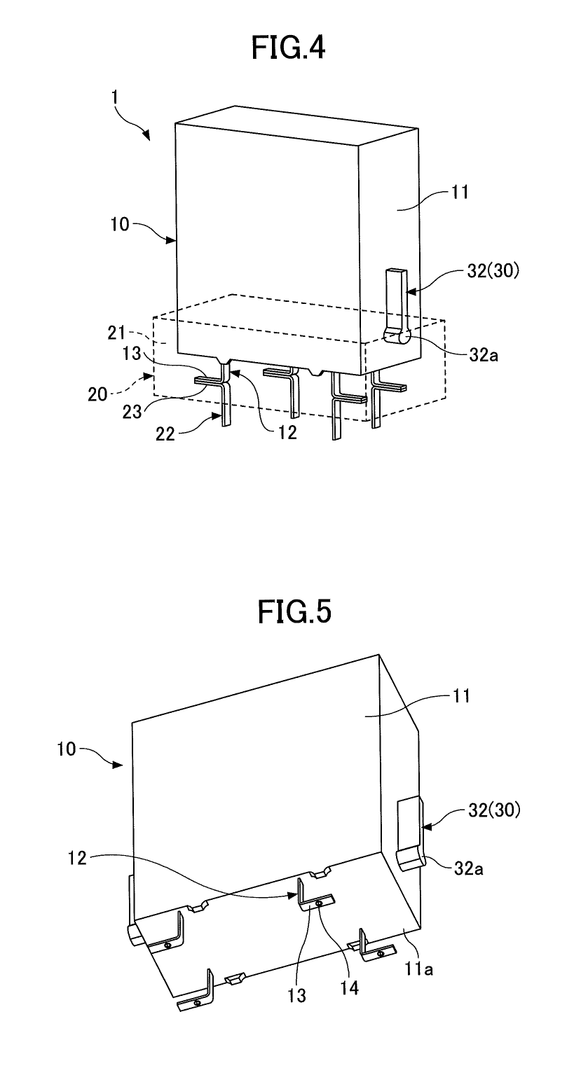

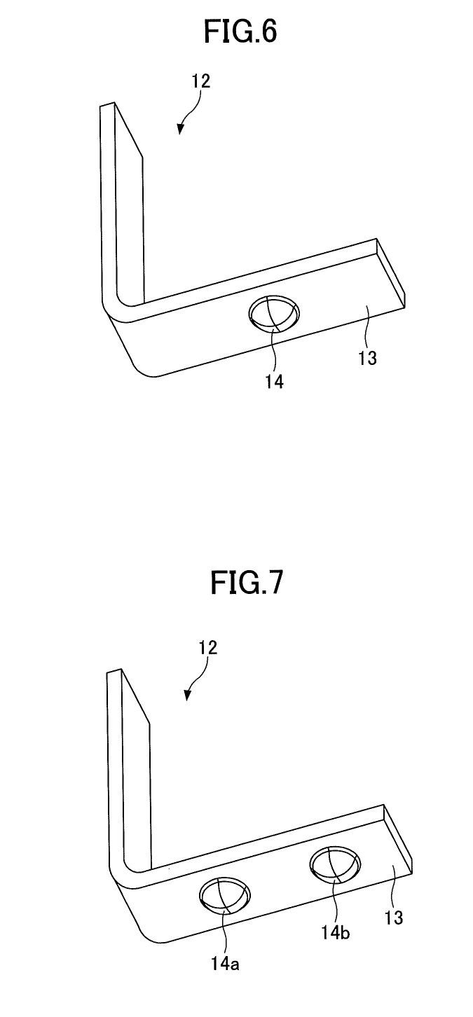

FIG. 1 is a perspective view of the first embodiment illustrating a state in which the electromagnetic relay 10 and the socket 20 are separated. FIG. 2 is a perspective view illustrating the state of FIG. 1 where a main body 21 of the socket 20 is not illustrated (schematically illustrated by a broken line). FIG. 3 is a perspective view illustrating a state in which the electromagnetic relay 10 and the socket 20 are fitted with each other. FIG. 4 is a perspective view illustrating the state of FIG. 3 where the main body 21 of the socket 20 is not illustrated. FIG. 5 is a perspective view of the electromagnetic relay 10 seen from a lower side. FIG. 6 is a perspective view of a terminal 12 of the electromagnetic relay 10.

As illustrated in FIGS. 1 to 4, the electromagnetic relay unit 1 includes the electromagnetic relay 10 and the socket 20 that connects the electromagnetic relay 10 to a mount board (not illustrated).

The electromagnetic relay 10 includes the main body 11 having a substantially rectangular parallelepiped shape, and four terminals 12 (first terminals). Components such as an electromagnet, a movable contact member and a fixed contact member are housed in the main body 11. The four terminals 12 are protruded from the lower surface 11a.

The terminal 12 is a plate-like terminal, and is bent once at a portion that is protruded from the main body 11 in a substantially perpendicular direction to form a plate portion 13 (first plate portion) at its front end. In other words, the terminal 12 is formed in an L-shape such that a base extends in a lower direction, which is substantially perpendicular to the lower surface 11a and is bent to extend in the horizontal direction, which is substantially in parallel to the lower surface 11a at a front end. The plate portion 13 is substantially in parallel to the lower surface 11a.

The socket 20 includes the main body 21 having a box shape, and four terminals 22 (second terminals). The main body 21 is capable of fitting with the electromagnetic relay 10. The main body 21 includes the bottom surface 21a that faces the lower surface 11a of the electromagnetic relay 10 when the electromagnetic relay 10 is fitted with the socket 20.

The four terminals 22 are provided at the bottom surface 21a and are capable of being electrically connected with the terminals 12, respectively.

Similarly as the terminal 12, the terminal 22 is a plate-like terminal, and is bent once in a substantially perpendicular direction to form a plate portion 23 (second plate portion) at its front end. In other words, the terminal 22 is formed in an L-shape such that a base extends in an upper direction, which is substantially perpendicular to the bottom surface 21a, and is bent to extend in the horizontal direction, which is substantially in parallel to the bottom surface 21a at a front end. The plate portion 23 (second plate portion) is substantially in parallel to the bottom surface 21a. The terminal is attached to the main body 21 of the socket 20 such that a surface of the plate portion 23 is positioned at the bottom surface 21a.

In the electromagnetic relay unit 1, when the electromagnetic relay 10 is fitted with the socket 20, the electromagnetic relay 10 is fixed to the socket 20 by a snap-fit structure 30. Here, “snap-fit” is one of mechanical joint methods that is used for connection of a metal, plastic and the like, and means a method of fixing that uses elasticity of a material to fit components with each other.

The snap-fit structure 30 includes locking portions 32 respectively provided at side surfaces of the electromagnetic relay 10, and snap-fit portions 31 provided at the socket 20 to respectively correspond to the locking portions 32. The locking portion 32 locks the respective snap-fit portion 31. The snap-fit portion 31 includes a pair of cantilever hooks 31a and 31b. The hooks 31a and 31b are aligned to have a predetermined space therebetween in the horizontal direction, and are deformable such that a distance between the hooks 31a and 31b is broaden by external force. The locking portion is provided to extend in the upper-lower direction, and a head 32a is provided at its lower end. A width of the head 32a in the horizontal direction is larger than the distance between the hooks 31a and 31b of the snap-fit portion 31. The snap-fit portion 31 and the respective locking portion 32 are provided at positions such that to face with each other when inserting the electromagnetic relay 10 in the socket 20 and to be connected when the electromagnetic relay 10 fits with the socket 20.

When fitting the electromagnetic relay 10 with the socket 20, the electromagnetic relay 10 is pushed downward. With this, the head 32a of the locking portion 32 touches the respective hooks 31a and 31b. Then, when the electromagnetic relay 10 is further pushed downward, the head 32a broadens the distance between the hooks 31a and 31b and moves down to a space under the hooks 31a and 31b. After the head 32a passes through the space between the hooks 31a and 31b, the distance between the hooks 31a and 31b returns to its original distance, and the locking portion 32 is sandwiched by the hooks 31a and 31b. With this, as illustrated in FIG. 3, the hooks 31a and 31b are locked by the respective locking portion 32.

When detaching the electromagnetic relay 10 from the socket 20 from the fitted state illustrated in FIG. 3, the electromagnetic relay is moved upward. Then, when the electromagnetic relay 10 is further pushed upward, the head 32a broadens the distance between the hooks 31a and 31b and moves up above the hooks 31a and 31b. With this, the snap-fit portion 31 is separated from the respective locking portion 32.

By providing such a snap-fit structure 30, the electromagnetic relay 10 fitted with the socket 20 can be stably fixed to the socket 20.

As illustrated in FIG. 4, in the first embodiment, the plate portions 13 of the electromagnetic relay 10 and the plate portions of the socket 20 are provided to face with each other, respectively, when fitting the electromagnetic relay 10 with the socket 20. As illustrated in FIG. 5 and FIG. 6, a projection 14 is provided at each of the plate portions 13 that contact the respective plate portion 23.

The projection 14 protrudes from a surface of the plate portion 13 at a plate portion 23 side. As illustrated in FIG. 6, the projection 14 has a substantially semi-spherical shape, for example. The terminal 12 is electrically connected with the plate portion 23 of the respective terminal 22 via the projection 14 provided at the plate portion 13.

It is theoretically known that vibration that transmits in an object is reduced when a cross-sectional area of a transmission path of the vibration is varied (Junichi Maekawa, “Architectural acoustics (Third edition)”, KYORITSU SHUPPAN, for example). According to this theory, a reduction degree of the vibration becomes larger when the variance of the cross-sectional area of the transmission path is larger. Further, it is also known that, as friction occurs at a point where objects are contacted with each other, vibration that transmits from one of the objects to the other of the objects is attenuated at the contacted position.

The present inventors studied hard based on these theories to find that the vibration generated by the operation of the electromagnetic relay 10 can be suppressed from transmitting to the mount board by providing the projection 14 at the front end of the terminal 12. With this configuration, the vibration generated by the operation of the electromagnetic relay 10 is transmitted from the plate portion 13 to the respective projection 14 of the terminal 12, to the plate portion 23 of the respective terminal and to the mount board. In other words, the transmission path is from the plate portion 13 to the respective projection 14 of the terminal 12, to the plate portion 23 of the respective terminal 22 and to the mount board.

As the projection 14 has a semi-spherical shape, the projection 14 point contacts the respective plate portion 23. Thus, the cross-sectional area of the transmission path becomes extremely small at a contact portion of the projection 14 and the plate portion 23. Thus, by providing the projection 14, variance of the cross-sectional area of the transmission path can be made large, and the reduction degree of the vibration can be made larger.

Further, as the projection 14 of the electromagnetic relay 10 and the respective plate portion 23 of the socket 20 are not bonded by solder or the like, the projection 14 can slide on the respective plate portion 23. Thus, friction occurs between the projection 14 and the plate portion 23 when they contact with each other, and vibration can be attenuated. Here, the projection 14 is provided at only a part of the plate portion 13, and an area (two dimensions) of the projection 14 is smaller than an area of the plate portion 13.

As such, according to the electromagnetic relay unit 1, by providing the projection 14 at the front end of each of the terminals 12, vibration generated by the operation of the electromagnetic relay 10 can be suppressed from transmitting to the mount board via the socket 20, and the electromagnetic relay 10 can be silently operated.

The number of the projections 14 provided to each of the terminals 12 is not limited to one. As illustrated in FIG. 7, for example, two projections 14a and 14b may be provided to each of the terminals 12, or three or more projections may be provided to each of the terminals 12. As long as the terminal 12 of the electromagnetic relay 10 and the respective terminal 22 of the socket 20 are connected via an object whose cross-sectional area is smaller than that of the plate portion 13 or 23, the projection 14 may be in any form.

### Second Embodiment

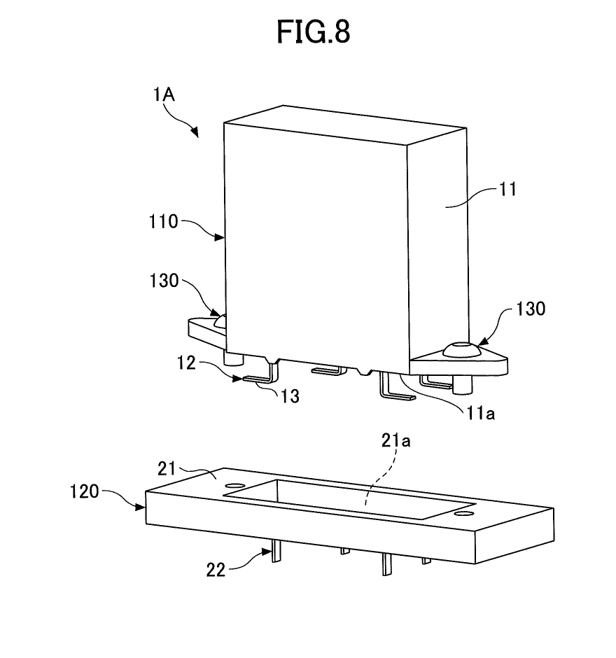

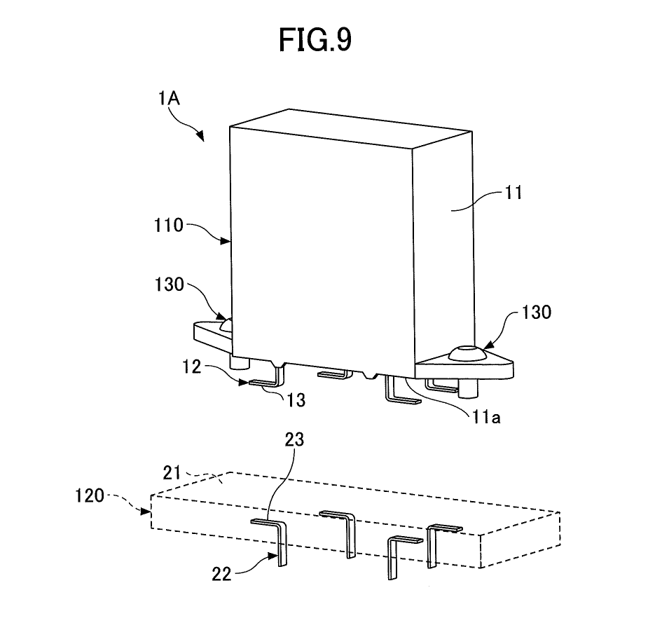

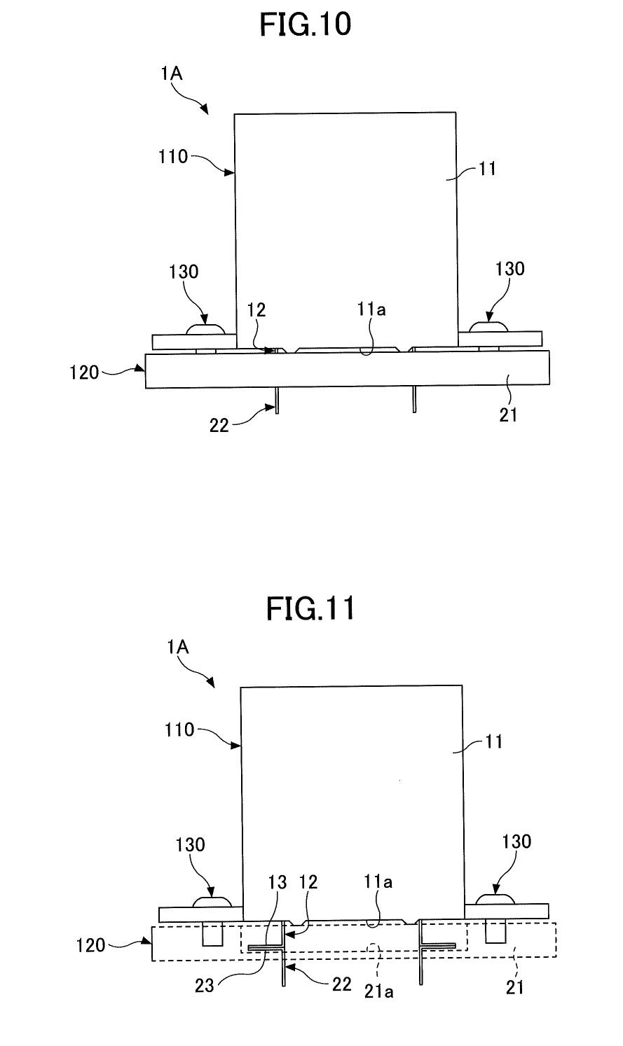

With reference to FIG. 8 to FIG. 11, an electromagnetic relay unit 1A of a second embodiment is described. FIG. 8 is a perspective view of the second embodiment illustrating a state in which an electromagnetic relay 110 and a socket 120 are separated. FIG. 9 is a perspective view illustrating the state of FIG. 8 where the main body 21 of the socket 120 is not illustrated. FIG. 10 is an elevation view illustrating a state in which the electromagnetic relay 110 and the socket 120 are fitted with each other. FIG. 11 is an elevation view illustrating the state of FIG. 10 where the main body 21 of the socket 120 is not illustrated.

As illustrated in FIG. 8 to FIG. 11, in the electromagnetic relay unit 1A, when the electromagnetic relay 110 is fitted with the socket 120, the electromagnetic relay 110 is fixed to the socket 120 by screws 130. By providing a fastening structure by the screws 130, the electromagnetic relay 110 fitted with the socket 120 can be stably fixed to the socket 120.

### Third Embodiment

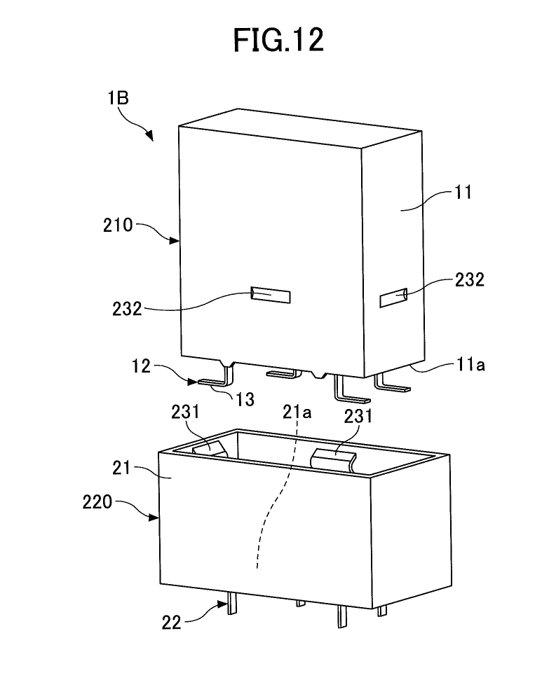

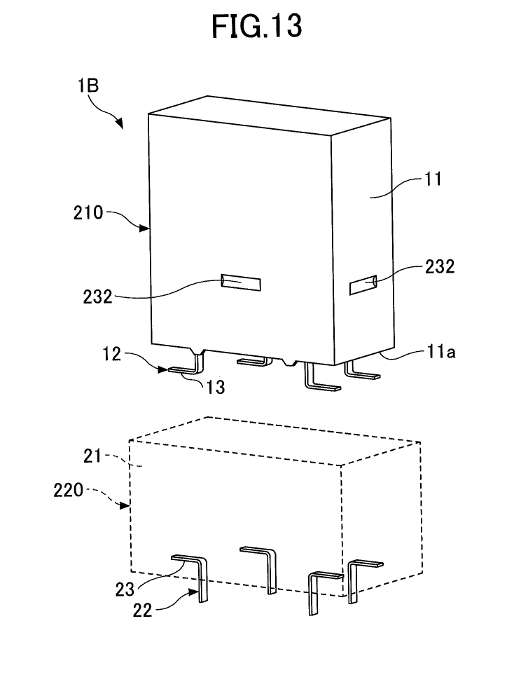

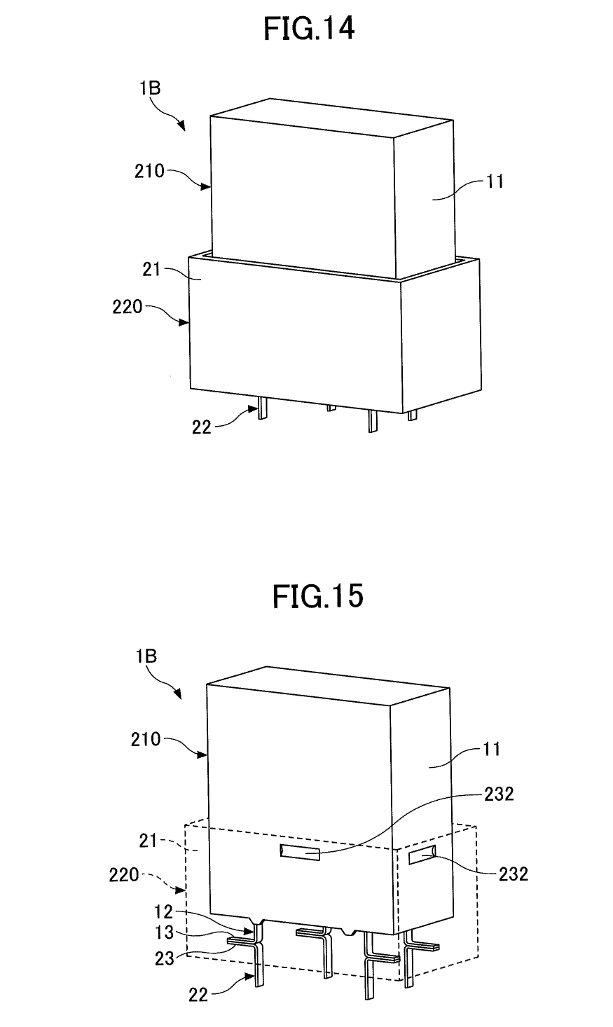

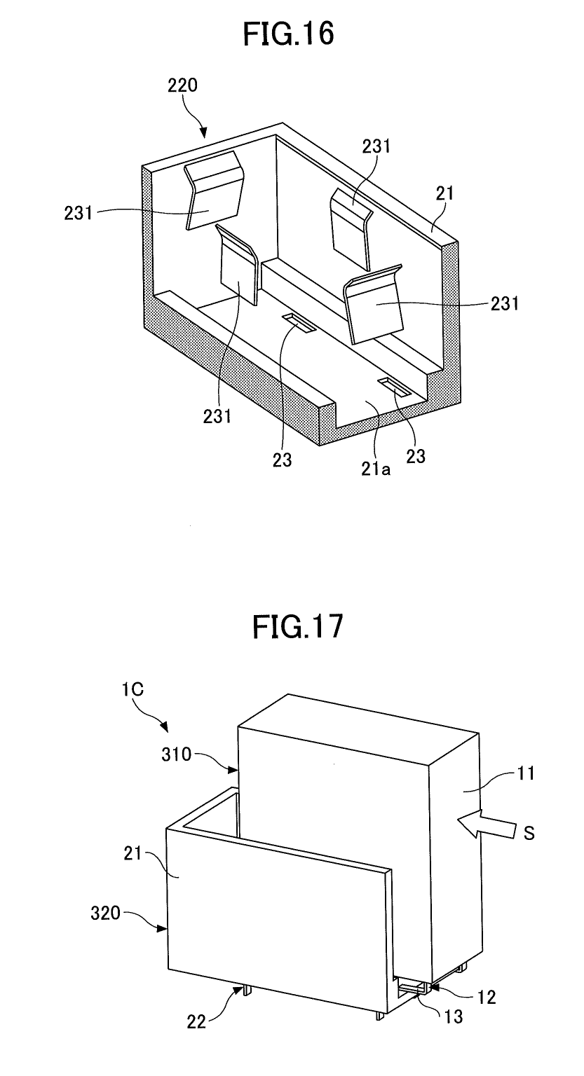

With reference to FIG. 12 to FIG. 16, an electromagnetic relay unit 1B of a third embodiment is described. FIG. 12 is a perspective view of the third embodiment illustrating a state in which an electromagnetic relay 210 and a socket 220 are separated. FIG. 13 is a perspective view illustrating the state of FIG. 12 where the main body 21 of the socket 220 is not illustrated. FIG. 14 is a perspective view illustrating a state in which the electromagnetic relay 210 and the socket 220 are fitted with each other. FIG. 15 is a perspective view illustrating the state of FIG. 14 where the main body 21 of the socket 220 is not illustrated. FIG. 16 is a partially cross-sectioned perspective view illustrating the socket 220.

As illustrated in FIG. 12 to FIG. 16, in the electromagnetic relay unit 1B, when the electromagnetic relay 210 is fitted with the socket 220, the electromagnetic relay 210 is fixed to the socket 220 by locking elastic members 231 provided at the socket 220 by locking portions 232 provided at the electromagnetic relay 210, respectively.

As illustrated in FIG. 16, four elastic members 231 are provided at four inner wall surfaces of the main body 21 of the socket 220, respectively. The elastic member 231 is configured, when the electromagnetic relay 210 is fitted with the socket 220, to push the main body of the electromagnetic relay 210 by generating force toward a center side of the main body 21 of the socket 220. The elastic member 231 is a leaf spring, for example.

With reference to FIG. 12, four locking portions 232 are provided at four outer wall surfaces of the main body 11 of the electromagnetic relay 210 to correspond to the elastic members 231 of the socket 220, respectively. As illustrated in FIG. 15, the locking portion 232 and the respective elastic member 231 are provided at positions such that to face with each other when fitting the electromagnetic relay 210 with the socket 220. The locking portion 232 is, for example, a concave portion in which the respective elastic member 231 is fitted. The locking portion 232 may be a hole, a protrusion and the like, in addition to the concave portion, as long as the elastic member 231 can be locked by the locking portion 232.

As such, by providing a locking structure (locking mechanism) by the elastic members 231 and the locking portions 232, the electromagnetic relay 210 fitted with the socket 220 can be stably fixed to the socket 220.

Alternatively, the locking portions 232 may not be provided in the electromagnetic relay 210, and a structure in which the electromagnetic relay 210 is fixed to the socket 220 only by pressing force of the elastic members 231 of the socket 220 may be adopted.

### Fourth Embodiment

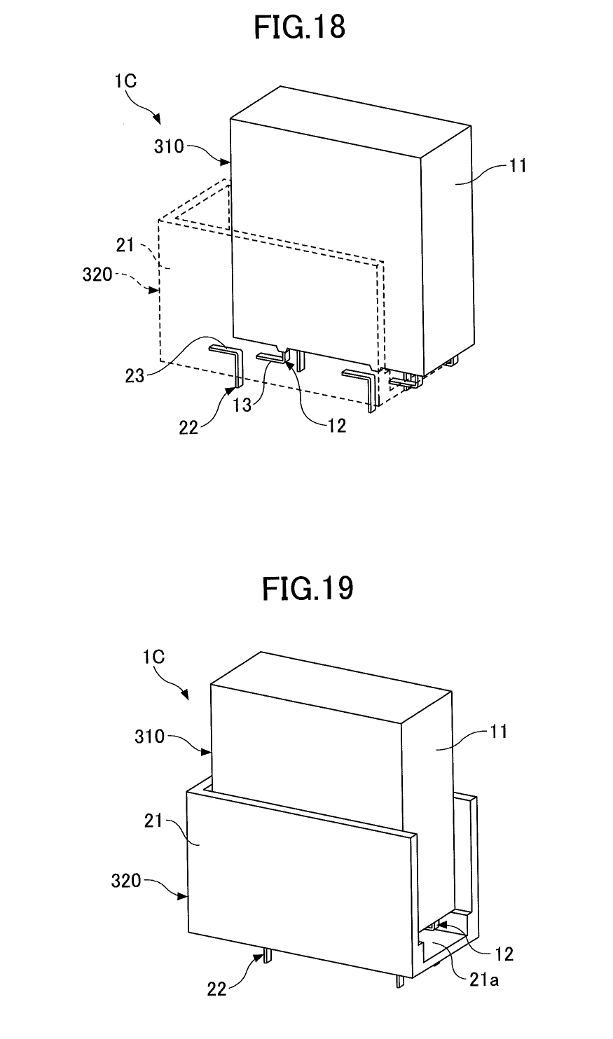

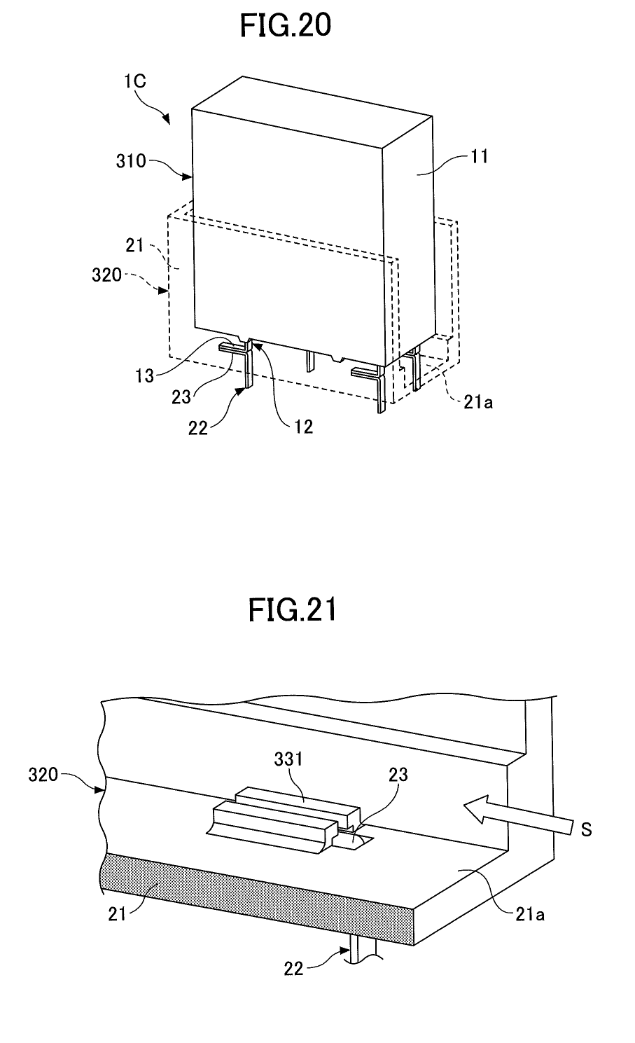

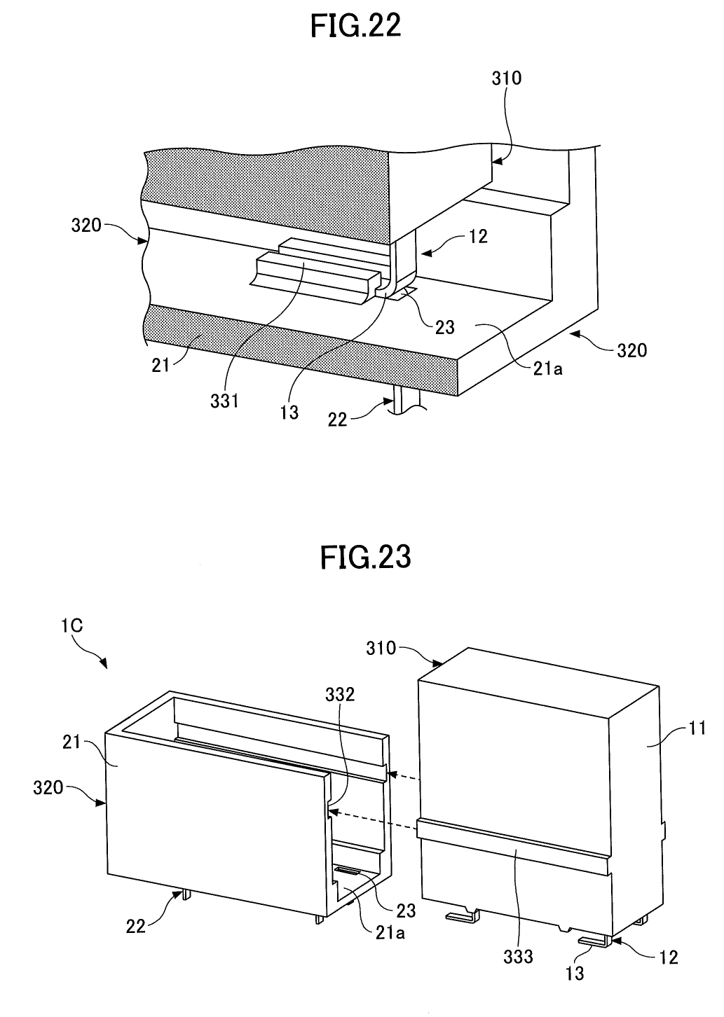

With reference to FIG. 17 to FIG. 22, an electromagnetic relay unit 1C of a fourth embodiment is described. FIG. 17 is a perspective view of the fourth embodiment illustrating a state in which an electromagnetic relay 310 and a socket 320 are separated. FIG. 18 is a perspective view illustrating the state of FIG. 17 where the main body 21 of the socket 320 is not illustrated. FIG. 19 is a perspective view illustrating a state in which the electromagnetic relay 310 and the socket 320 are fitted with each other. FIG. 20 is a perspective view illustrating the state of FIG. 19 where the main body 21 of the socket 320 is not illustrated. FIG. 21 is an enlarged partially cross-sectioned perspective view illustrating the vicinity of the terminal 22 of the socket 320. FIG. 22 is an enlarged partially cross-sectioned perspective view illustrating the vicinity of the terminals 12 and 22 at a state in which the electromagnetic relay 310 and the socket 320 are fitted with each other.

As illustrated in FIG. 17 to FIG. 22, the electromagnetic relay unit 1C is fixed to the socket 320 by sliding the electromagnetic relay 310 in a direction that is perpendicular to the facing direction of the plate portions 13 and 23 (indicated by an arrow “S” in FIG. 17, and also the horizontal direction) with respect to the socket 320.

The main body 21 of the socket 320 has a substantially rectangular parallelepiped box like shape in which one of four side walls of the box is removed and has a shape capable of housing the electromagnetic relay 310. In other words, the main body 21 includes the rectangular bottom surface 21a and three side walls extending upward from three sides of the bottom surface 21a, respectively. The electromagnetic relay 310 can be inserted in the main body 21 from a side where a side wall is not provided by sliding the electromagnetic relay 310 in the horizontal direction.

As illustrated in FIG. 21, the socket 320 includes terminal holding portions 331 at positions of the bottom surface 21a where the plate portions 23 of the terminals 22 are respectively provided. The terminal holding portion 331 is formed such that the plate portion of the respective terminal 12 of the electromagnetic relay 310 is capable of being inserted at a position right above the respective plate portion 23 along the sliding direction of the electromagnetic relay 310. When fitting the electromagnetic relay 310 with the socket 320, by inserting the plate portion 13 in the terminal holding portion 331 to guide in the sliding direction, the electromagnetic relay 310 can be smoothly moved to a position to be fixed. Further, when the electromagnetic relay 310 is inserted in the socket 320 to the position to be fixed, the plate portion 13 is sandwiched by the respective terminal holding portion 331 and the plate portion 23 of the respective terminal 22 at the bottom surface 21a as illustrated in FIG. 22. Thus, the electromagnetic relay 310 can be stably fixed to the socket 320.

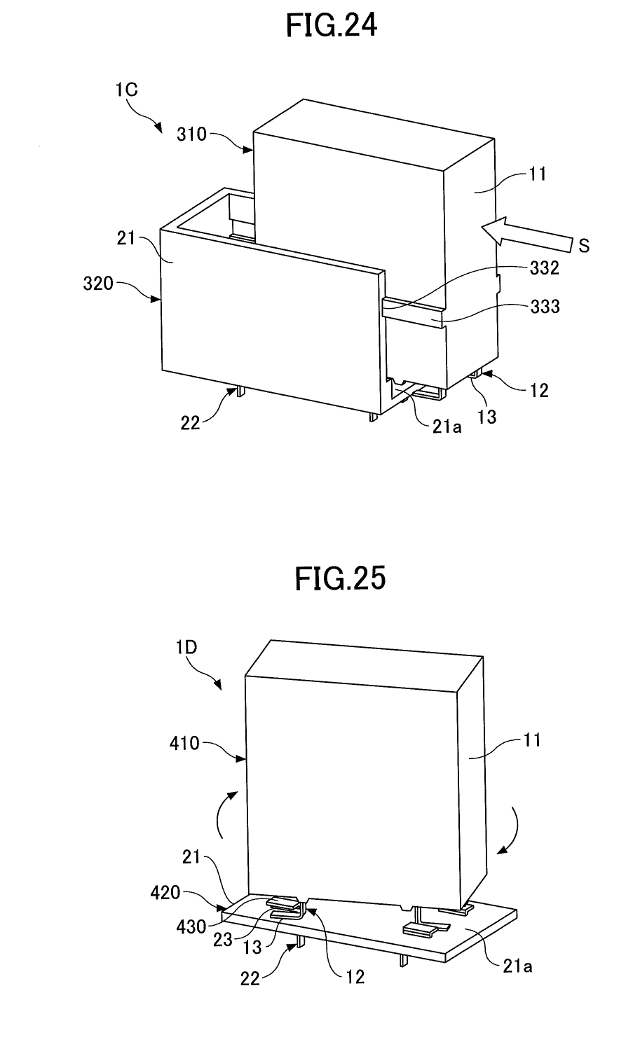

Alternatively, the electromagnetic relay 310 may be fixed to the socket 320 by a structure other than the terminal holding portions 331. FIG. 23 is a perspective view of a modified example of the fourth embodiment illustrating a state in which the electromagnetic relay 310 and the socket 320 are separated. FIG. 24 is a perspective view of the modified example illustrating a state in which the electromagnetic relay 310 is inserted in the socket 320.

For example, as illustrated in FIG. 23 and FIG. 24, grooves may be respectively provided at the inner wall surfaces of the socket 320 along the sliding direction, and protrusions 333 may be provided at the side surfaces of the electromagnetic relay 310 at positions facing with the grooves 332, respectively. According to the structure of FIG. 23 and FIG. 24, when fitting the electromagnetic relay 310 with the socket 320, by inserting the protrusions 333 in the grooves 332 to guide in the sliding direction, respectively, the electromagnetic relay 310 can be smoothly moved to a position to be fixed. Further, when the electromagnetic relay 310 is inserted in the socket 320 to the position to be fixed, the protrusions 333 engage with the grooves 332, respectively. Thus, the electromagnetic relay 310 can be stably fixed to the socket 320.

### Fifth Embodiment

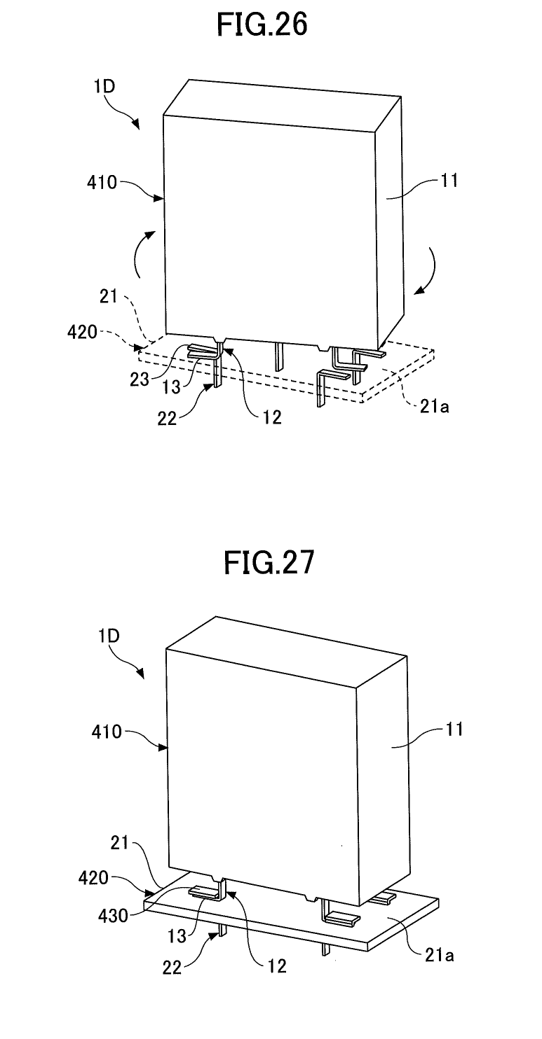

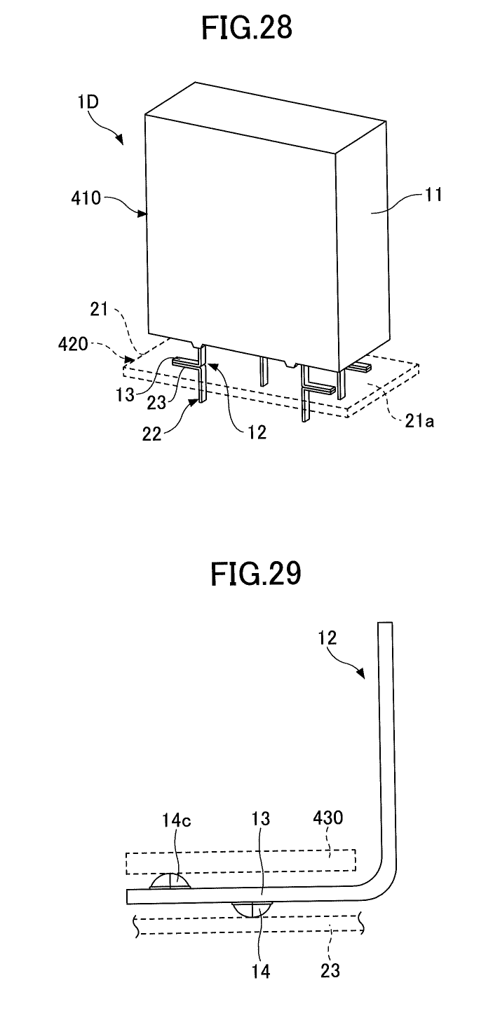

With reference to FIG. 25 to FIG. 28, an electromagnetic relay unit 1D of a fifth embodiment is described. FIG. 25 is a perspective view of the fifth embodiment illustrating a state in which an electromagnetic relay 410 and a socket 420 are separated. FIG. 26 is a perspective view illustrating the state of FIG. 25 where the main body 21 of the socket 420 is not illustrated. FIG. 27 is a perspective view illustrating a state in which the electromagnetic relay 410 and the socket 420 are fitted with each other. FIG. 28 is a perspective view illustrating the state of FIG. 27 where the main body 21 of the socket 420 is not illustrated.

As illustrated in FIG. 25 to FIG. 28, the electromagnetic relay unit 1D of the fifth embodiment is fixed to the socket 420 by rotating the electromagnetic relay 410 with respect to the socket 420 around a rotation axis in the facing direction of the plate portions 13 and 23 (upper-lower direction).

As illustrated in FIG. 25 and FIG. 26, the electromagnetic relay 410 is placed on the bottom surface 21a of the socket 420 at a position at which the plate portion 13 of each of the terminals 12 is shifted from the respective plate portion 23 of the socket 420 around the rotation axis (at a position rotated in a anticlockwise direction when seen from an upper side in FIG. 25 and FIG. 26). Thereafter, by rotating the electromagnetic relay 410 with respect to the socket 420 in a direction by which the position of each of the plate portions 13 matches the respective plate portion 23 (a clockwise direction when seen from the upper side in FIG. 25 and FIG. 26), the electromagnetic relay 410 is fixed to the socket 420 as illustrated in FIG. 27 and FIG. 28.

As illustrated in FIG. 25 and FIG. 27, the socket 420 includes terminal holding portions 430 at positions of the bottom surface 21a where the plate portions 23 of the terminals 22 are respectively provided. The terminal holding portion 430 is formed such that the respective plate portion 13 is capable of being inserted at a position right above the respective plate portion 23 along the rotational direction of the electromagnetic relay 410. When the electromagnetic relay 410 is rotated with respect to the socket 420 to a position to be fixed, the plate portion 13 is sandwiched by the terminal holding portion 430 and the plate portion 23 of the respective terminal 22 at the bottom surface 21a as illustrated in FIG. 27 (see also FIG. 25). Thus, the electromagnetic relay 410 can be stably fixed to the socket 420.

As illustrated in FIG. 29, in the fifth embodiment, a projection 14c may be provided at a surface of each of the plate portions 13 that is opposite to the surface at which the projection is provided. When the plate portion 13 is inserted in the respective terminal holding portion 430, the projection 14 contacts the plate portion 23 of the respective terminal 22 while the projection 14c contacts the terminal holding portion 430. As the plate portion 13 surely contacts the terminal holding portion 430 by the projection 14c, the plate portion 13 can receive counterforce. Thus, the terminal holding portion 430 can furthermore strongly hold the plate portion 13 with the plate portion. Thus, the electromagnetic relay 410 can be furthermore stably fixed to the socket 420.

### Sixth Embodiment

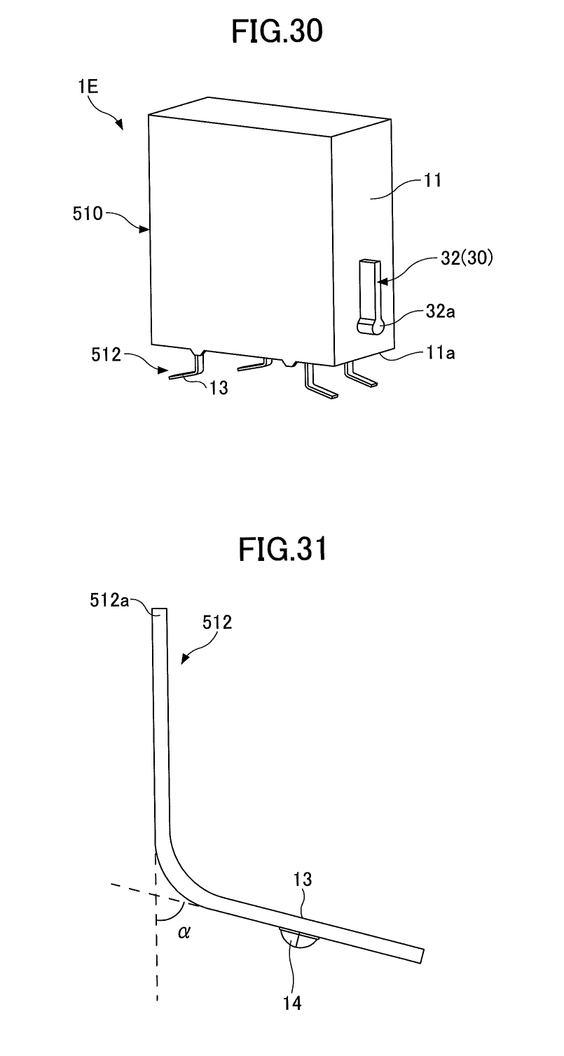

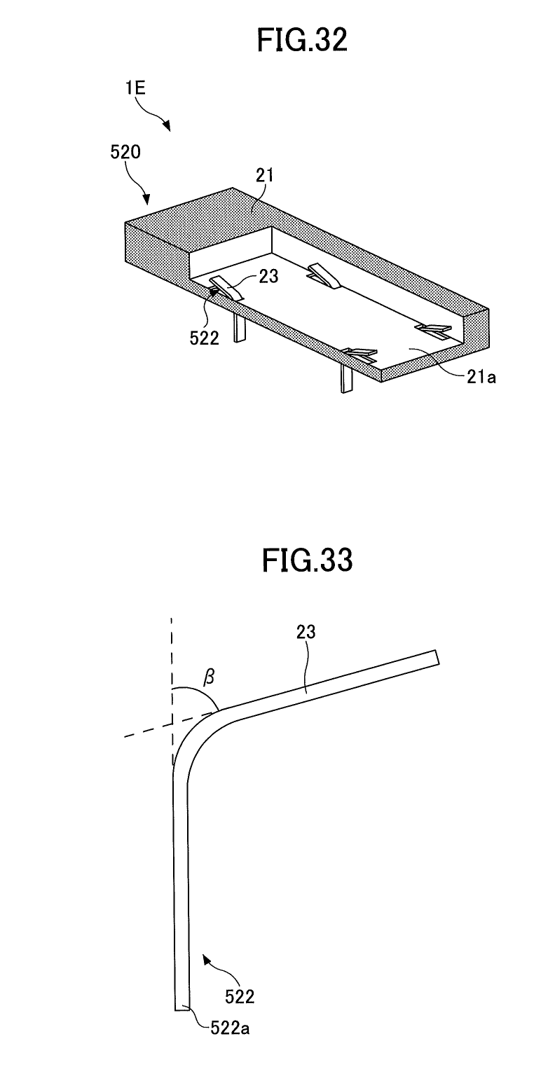

With reference to FIG. 30 to FIG. 33, an electromagnetic relay unit 1E of a sixth embodiment is described. FIG. 30 is a perspective view illustrating an electromagnetic relay 510 of the sixth embodiment. FIG. 31 is a side view illustrating terminals 512 of the electromagnetic relay 510. FIG. 32 is a partially cross-sectioned perspective view of a socket 520 of the sixth embodiment. FIG. 33 is a side view of a terminal 522 of the socket 520.

For the electromagnetic relay unit 1E of the sixth embodiment, a structure for fixing, fastening or locking the electromagnetic relay 510 with the socket 520 may be one same as that of the above described first to fifth embodiments and the like. As an example, a structure in which the fitting structure of the first embodiment is adopted is illustrated in FIG. 30 to FIG. 32. As illustrated in FIG. 30, similarly as the electromagnetic relay 10 of the first embodiment, the electromagnetic relay 510 includes the locking portions 32 of the snap-fit structure 30 at each of the side surfaces. Further, although not illustrated in FIG. 32, similarly as the socket 20 of the first embodiment, the socket 520 includes the snap-fit portions 31 of the snap-fit structure 30.

As illustrated in FIG. 30 and FIG. 31, according to the electromagnetic relay unit 1E of the sixth embodiment, the plate portion 13 of each terminal 512 does not extend in the horizontal direction. A bending angle “a” of the plate portion 13 with respect to a base 512a of the terminal 512 is less than 90 degrees, and thus, the plate portion 13 is not in parallel to the lower surface 11a of the main body 11 but is inclined in the lower direction. With this configuration, the terminal 512 configured to be pushed in a direction (the lower direction in FIG. 30 and FIG. 31) in which the plate portion and the plate portion 23 are approaching with each other.

Thus, the terminal 512 has spring characteristics like a leaf spring, and when the electromagnetic relay 510 is fitted with the socket 520, counterforce received from a terminal 522 to which the plate portion 13 contacts becomes larger. Then, as the terminal 512 is elastically deformed toward the main body 11 by this counterforce, repulsive force is generated at the terminal 512 toward the respective plate portion 23 of the socket 520.

As such, when the terminal 512 has spring characteristics, the projection 14 provided at the terminal 512 can furthermore strongly contact the plate portion 23 of the socket 520. Thus, the terminals 512 and 522 can furthermore stably contact with each other.

As illustrated in FIG. 32 and FIG. 33, according to the electromagnetic relay unit 1E, the plate portion 23 of the terminal 522 does not extend in the horizontal direction. Similarly as the terminal 512, a bending angle “β” of the plate portion 23 with respect to a base 522a of the terminal 522 is less than 90 degrees, and the plate portion 23 is not in parallel to the bottom surface 21a but is inclined in the upper direction. With this configuration, the terminal 522 is configured to be pushed in a direction (the upper direction in FIG. 32 and FIG. 33) in which the plate portion 13 and the plate portion 23 are approaching with each other.

Thus, the terminal 522 has spring characteristics like a leaf spring, and when the electromagnetic relay 510 is fitted with the socket 520, counterforce received from the projection 14 to which the plate portion 23 contacts becomes larger. Then, as the terminal 522 is elastically deformed toward the bottom surface 21a by this counterforce, repulsive force is generated at the terminal 522 toward the plate portion 13 of the electromagnetic relay 510.

As such, when the terminal 522 has spring characteristics, the plate portion 23 of the terminal 522 can furthermore strongly contact the projection 14 of the electromagnetic relay 510. Thus, the terminals 512 and 522 can furthermore stably contact with each other.

Here, a structure in which either of the terminals 512 of the electromagnetic relay 510 and the terminals 522 of the socket 520 has spring characteristics may also be adopted.

### Seventh Embodiment

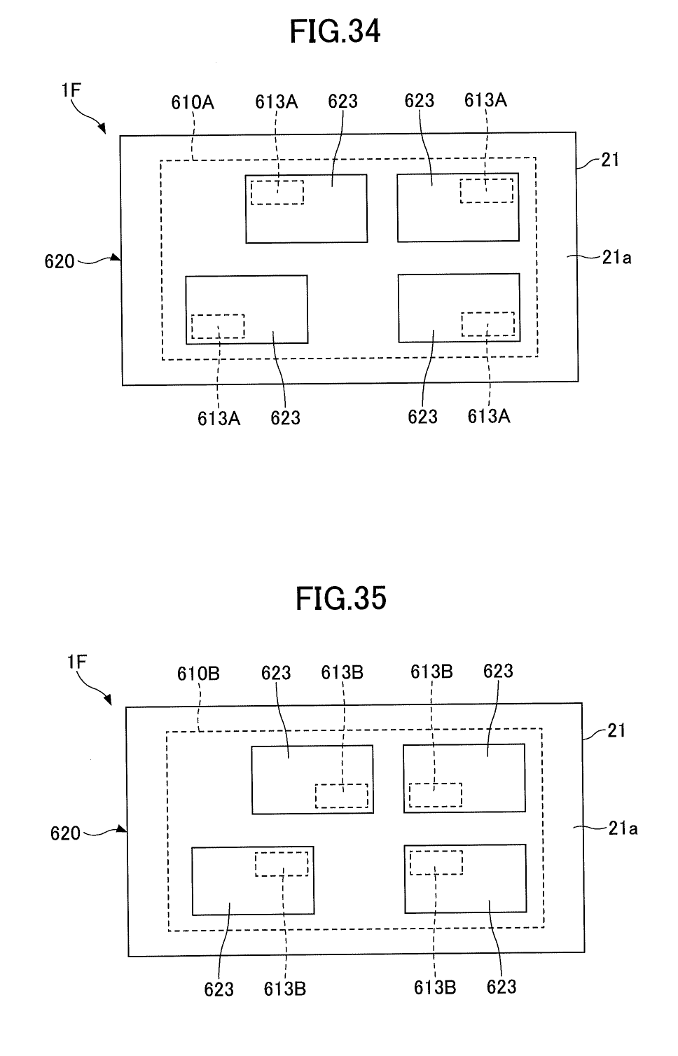

With reference to FIG. 34 and FIG. 35, an electromagnetic relay unit 1F of a seventh embodiment is described. FIG. 34 is a view of the seventh embodiment schematically illustrating an example of a relationship between an arrangement of plate portions 623 of terminals of a socket 620 and an arrangement of plate portions 613A of terminals of an electromagnetic relay 610A. FIG. 35 is a view of another example of the seventh embodiment schematically illustrating a relationship between an arrangement of the plate portions 623 of the terminals of the socket 620 and an arrangement of plate portions 613B of terminals of an electromagnetic relay 610B.

As illustrated in FIG. 34 and FIG. 35, according to the electromagnetic relay unit 1F of the seventh embodiment, an area of each of the plate portions 623 of the socket 620 at a surface facing with the electromagnetic relay 610A or 610B is larger than an area of the respective plate portion 613A or 613B of the electromagnetic relay 610A or 610B, respectively. With this configuration, arrangement patterns of the terminals of the electromagnetic relay 610A or 610B that can connected to the terminals of the socket 620 can be increased. For example, as the electromagnetic relay 610A of FIG. 34 and the electromagnetic relay 610B of FIG. 35, even when the arrangement of the plate portions 613A or 613B of the terminals is different, as long as the plate portions 613A and 613B can be provided to face with the plate portions 623 of the terminals of the socket 620, the terminals of the electromagnetic relay 610A or 610B and the terminals of the socket 620 can be connected, respectively.

Although not illustrated in some drawings of the second to seventh embodiment, similarly as the first embodiment, the projection 14 may be provided at the plate portion of the front end of each of the terminals of the electromagnetic relay. With this, vibration generated by the operation of the electromagnetic relay can be suppressed from transmitting to a mount board via the respective socket, and the electromagnetic relay can be silently operated.

According to the disclosure, an electromagnetic relay unit capable of suppressing generation of sound noise of the electromagnetic relay can be provided.

Although an embodiment of the electromagnetic relay unit has been specifically illustrated and described, it is to be understood that minor modifications may be made therein without departing from the spirit and scope of the invention as defined by the claims.

The present invention is not limited to the disclosed embodiments, and numerous variations and modifications may be made without departing from the spirit and scope of the present invention. The placement, material, condition, shape, size and the like of each component are not limited to the described examples, and may be appropriately modified. Further, components described in different embodiments or examples may be partially substituted by each other, or combined with each other.

Although the example in which the projection is provided at each of the terminals of the electromagnetic relay is described in the above embodiments, a projection may be provided at each of the terminals of the socket.

Although the example in which each of the electromagnetic relay and the socket includes four terminals is described in the above embodiments, the number of the terminals is not limited so, and the number of the terminals may be one, or plural.

Although the example in which the terminal has an L-shape that is bent at one position is described in the above embodiments, as long as the terminal has a plate portion to face with a respective plate portion, the terminal may be bent for a plurality of times.

What is claimed is:

1. An electromagnetic relay unit comprising:
an electromagnetic relay;
a socket that connects the electromagnetic relay to a mount board;
a first terminal provided at the electromagnetic relay and including a first plate portion; and
a second terminal provided at the socket to be connectable with the first terminal, and including a second plate portion,
the first plate portion and the second plate portion being provided to face with each other when the electromagnetic relay and the socket are connected with each other,
at least one of the first plate portion and the second plate portion including a projection that contacts the other of the first plate portion and the second plate portion.

2. The electromagnetic relay unit according to claim 1, wherein the electromagnetic relay is configured to be fixed to the socket by being slid in a direction that is perpendicular to a facing direction of the first plate portion and the second plate portion.

3. The electromagnetic relay unit according to claim 1, wherein the electromagnetic relay is configured to be fixed to the socket by being rotated around a rotation axis that is in a facing direction of the first plate portion and the second plate portion.

4. The electromagnetic relay unit according to claim 1, wherein either one of the first terminal and the second terminal is configured to be pushed in a direction in which the first plate portion and the second plate portion are approaching with each other.

5. The electromagnetic relay unit according to claim 1, wherein an area of a surface of the second plate portion that faces the first plate portion is larger than an area of a surface of the first plate portion that faces the second plate portion.
